(19) United States
(12) Patent Application Publication
(10) Pub. No.: US 2011/0127789 A1
(43) Pub. Date: Jun. 2, 2011

(54) WINDOW INSULATION KIT FOR INHABITABLE MULTI-WINDOWED VEHICLES

(76) Inventors: Gary Newman, Goodyear, AZ (US); Marcia Newman, Goodyear, AZ (US)

(21) Appl. No.: 12/955,778

(22) Filed: Nov. 29, 2010

Related U.S. Application Data
(60) Provisional application No. 61/265,834, filed on Dec. 2, 2009.

(51) Int. Cl. B60J 1/20; F25B 21/00; H05B 3/00

(52) U.S. Cl. 296/1.07; 62/3.1; 219/201

(57) ABSTRACT

A window insulation kit comprising a plurality of window covers sized to releasably couple to interior surfaces of an inhabitable multi-windowed vehicle and overlay those windows to create a light-tight and insulating covering of those windows. The basic kit includes the window covers, couplings, instructions, and implements used to assist in installing the window covers. The kit may also include one or more of an inhabitable multi-windowed vehicle, an electric heater, and an electric air conditioner. The kit may also include packaging having a transparent portion to allow the consumer to view the window covers. The window covers may bear decoration, advertising, or other designs. The window covers are preferably opaque in the visible and infrared spectrum.

### RELATED APPLICATIONS

This application claims the benefit of U.S. Provisional Patent Application Ser. No. 61/265,834 filed Dec. 2, 2009 having at least one common inventor.

### FIELD OF THE INVENTION

This invention relates to window insulation kits for inhabitable multi-windowed vehicles. The invention more particularly relates to window insulation kits for over-the-road trucks.

### BACKGROUND

Over-the-road truckers are required to take 10-hour breaks between 14-hour driving stints. Over-the-road trucks have sleeping compartments to accommodate the drivers during these 10-hour breaks. Historically, truck engines were left idling during these breaks and supplied power for air conditioning and heating the truck. With new anti-pollution regulations limiting the idling of truck engines, battery-powered air conditioning and heating systems have been added to the over-the-road trucks. The truck battery powers the air conditioner or heater. In many conditions, such as the desert Southwest in Summer or the northern tier states in Winter, the batteries do not last long enough to maintain habitable temperatures during the entire 10-hour break period.

Because of the unusual hours truckers keep, there is also a need to limit the amount of light entering the truck during break periods. Modern over-the-road trucks have evolved from flat-topped trucks with aerodynamic cowlings to reduce drag into trucks that incorporate the aerodynamic cowlings into walls of larger sleeping compartments. Sleeping compartment s have often had their own side windows, and newer models have front windows as well. The shapes of the windows vary among various models of trucks, with the shapes ranging from simple geometric shapes to more complicated and aesthetically pleasing designs. Some over-the-road trucks feature separate access doors to the sleeping compartment and the driver's compartment, and each of these doors often have windows. Windows let in light and have poor insulative properties.

Over-the-road trucks may be equipped with privacy curtains for use during breaks. These curtains provide incomplete thermal and illumination barriers. Such curtains are also known to reduce the amount of usable space inside the truck when drawn for privacy. For example, a privacy curtain suspended inside the truck from the top of a sloping windshield, may cut off the entire dashboard area reducing the amount of usable space and creating a cramped feeling for the occupants. Likewise, privacy curtains between the driving compartment and the sleeping compartment render the sleeping compartment very cramped.

Rigid insulation panels known in the art, adapted to be placed on the dash board of a vehicle, usually a car, normally do not provide complete thermal insulation nor a substantially complete light barrier. Even then, such barriers address only the windshield.

Therefore, a need exists for easily installed thermal and illumination barriers for all the windows in an over-the-road truck. A need also exists for thermal and illumination barriers custom-made for particular models of trucks. A need also exists for kits having a complete set of window-cover thermal and illumination barriers and means to releasably attach the barriers to the inside of the truck. A need also exists for thermal and illumination barriers that give complete coverage to each window in the truck while limiting the installation costs.

### OBJECTS AND FEATURES OF THE INVENTION

A primary object and feature of the present invention is to overcome the above-mentioned problems and fulfill the above-mentioned needs.

Another object and feature of the present invention is to provide a kit containing thermal and illumination barriers custom made for particular truck models and containing barriers for all windows of the truck, as well as means for installing releasable couplings for the barriers around the windows. Another object and feature of the present invention is to provide thermal and illumination barriers that can be easily cleaned. Another object and feature of the present invention is to provide illumination barriers for privacy inside the truck during breaks, without significantly reducing the usable space within the truck. Another object and feature of the present invention is to provide a truck with releasable couplings for attaching the illumination and thermal barriers. Another object and feature of the invention is to reduce heat transfer into or out of the vehicle to enable electric air conditioners or electric heaters, respectively, to maintain a comfortable environmental temperature for ten hours.

It is an additional primary object and feature of the present invention to provide thermal and illumination barrier kit that is efficient, inexpensive, easy to clean, and handy. Other objects and features of this invention will become apparent with reference to the following descriptions.

### SUMMARY OF THE INVENTION

In accordance with a preferred embodiment hereof, this invention provides a kit containing customized window covers that act as thermal and illumination barriers, where each of the covers is shaped to fit a particular window and each window in the vehicle has a cover. The kit also contains couplings for releasably attaching the covers to the inside of the truck, and means for installing the couplings.

A kit for providing window insulation for a multi-windowed inhabitable vehicle, the kit including a plurality of opaque and insulated window covers, including one window cover corresponding to each the window in the multi-windowed inhabitable vehicle, where each the window cover is shaped conformally to the shape of a respective corresponding window and sized to extend beyond the perimeter of the respective corresponding window; a plurality of couplings able to couple each window cover of the plurality of window covers to a interior surface of the vehicle; a set of instructions able to present at least a method of employing the plurality of couplings to couple the plurality of the window covers to a interior surface of the vehicle. The kit, further including an implement for assisting in coupling the plurality of opaque and insulated window covers to the a interior surface of the vehicle. The kit, where the implement includes a marker and/or an adhesive dispenser. The kit, further including the multi-windowed inhabitable vehicle. The kit, further including an electric heater. The kit, further including an electric air conditioner. The kit, where the window cover is opaque to electromagnetic energy in the visible spectrum and in the infrared spectrum. The kit, where the window cover includes first and second opposed outer layers of a water-resistant fabric sandwiching a multilayer insulating material and a perimeter seam formed in the first and second opposed outer layers of the water-resistant fabric and the multilayer insulating material. The kit, where the multilayer insulating material includes soft bulk sufficient to enable the window cover to deform conformally to an edge feature of the window to produce a light-tight perimeter seal at an edge of the window. The kit, where the water-resistant fabric includes an outer surface adapted to support a additional material. The kit, where the plurality of couplings includes a coupling including first and second parts that are releasably attachable to each other, where the first releasably attachable part is fixable to an interior surface of the vehicle and the second releasably attachable part is fixable to the window cover. The kit, where the set of instructions may comprise a plurality of templates for arranging the plurality of couplings proximate a corresponding the plurality of windows and machine washing instructions for washing the window cover.

A kit for providing window insulation for a multi-windowed inhabitable vehicle, the kit including a plurality of opaque and insulated window covers, including one window cover corresponding to each window in the multi-windowed inhabitable vehicle, where each window cover is shaped conformally to the shape of a respective and corresponding window and sized to extend beyond the perimeter of the respective and corresponding window; a plurality of couplings able to couple each window cover of the plurality of window covers to an interior surface of the vehicle; a set of instructions able to present at least a method of employing the plurality of couplings to couple the plurality of the window covers to an interior surface of the vehicle; an implement for assisting in coupling the plurality of opaque and insulated window covers to an interior surface of the vehicle; where the window cover includes first and second opposed outer layers of a water-resistant fabric sandwiching a multilayer insulating material, where the multilayer insulating material includes soft bulk sufficient to enable the window cover to deform conformally to an edge feature of the window to produce a light-tight perimeter seal at an edge of the window; and a perimeter seam formed in the first and second opposed outer layers of the water-resistant fabric and the multilayer insulating material. The kit, further including the multi-windowed inhabitable vehicle. The kit, further including an electric heater. The kit, further including an electric air conditioner. The kit, where the window cover is opaque to electromagnetic energy in the visible spectrum and in the infrared spectrum. The kit, where the plurality of couplings includes a coupling further including first and second parts that are releasably attachable to each other, where the first releasably attachable part is fixable to an interior surface of the vehicle and the second releasably attachable part is fixable to the window cover.

A kit for providing window insulation for a multi-windowed inhabitable vehicle, the kit including a plurality of opaque and insulated window covers, including one window cover corresponding to each window in the multi-windowed inhabitable vehicle, where each window cover is sized to extend beyond the perimeter of the respective and corresponding window; and the window cover is opaque to electromagnetic energy in the visible spectrum and in the infrared spectrum; a plurality of couplings able to couple each window cover of the plurality of window covers to a interior surface of the vehicle, where the plurality of couplings includes a coupling further including first and second parts that are releasably attachable to each other, where the first releasably attachable part is fixable to an interior surface of the vehicle and the second releasably attachable part is fixable to the window cover; a set of instructions able to present a method of employing the plurality of couplings to couple the plurality of the window covers to an interior surface of the vehicle, where the set of instructions further includes a plurality of templates for arranging the plurality of couplings proximate a corresponding plurality of windows, where the template may be integral to the window cover; and machine washing instructions for washing the window cover; an implement for assisting in coupling the plurality of opaque and insulated window covers to the a interior surface of the vehicle; where the window cover includes first and second opposed outer layers of a water-resistant fabric sandwiching a multilayer insulating material, where: the multilayer insulating material includes soft bulk sufficient to enable the window cover to deform conformally to an edge feature of the window to produce a light-tight perimeter seal at an edge of the window; and the water-resistant fabric includes an outer surface adapted to support a additional material; a perimeter seam formed in the first and second opposed outer layers of the water-resistant fabric and the multilayer insulating material. The kit, further including the multi-windowed inhabitable vehicle, an electric heater, and/or an electric air conditioner.

### BRIEF DESCRIPTION OF THE DRAWINGS

The above and other objects and advantages of the present invention will become more apparent from the following description taken in conjunction with the following drawings in which:

FIG. 1 is a diagrammatic view illustrating an exemplary window insulation kit for inhabitable multi-windowed vehicles, according to a preferred embodiment of the present invention;

FIG. 2 is a diagrammatic view illustrating the reverse sides of the exemplary window thermal and illumination barriers of the exemplary window insulation kit for inhabitable multi-windowed vehicles, according to a preferred embodiment of FIG. 1;

FIG. 3 is a diagrammatic view illustrating another exemplary window insulation kit for inhabitable multi-windowed vehicles, according to a preferred embodiment of the present invention;

FIG. 4 is a side cross-section diagrammatic view of an exemplary window thermal and illumination barrier, according to a preferred embodiment of the present invention; and

FIG. 5 is a side cross-section diagrammatic view of a portion of a vehicle illustrating an exemplary vehicle window in a vehicle structure with portions of couplings attached thereto, according to a preferred embodiment of the present invention;

FIG. 6 is a side cross-section diagrammatic view illustrating the exemplary window thermal and illumination barrier of FIG. 4 coupled to the portion of the vehicle with portions of couplings attached thereto of FIG. 5 to cover the window, according to the preferred embodiment of FIG. 4 and FIG. 5; and

FIG. 7 is a diagrammatic view illustrating yet another exemplary window insulation kit for inhabitable multi-windowed vehicles, according to a preferred embodiment of the present invention.

### DETAILED DESCRIPTION OF THE BEST MODES AND PREFERRED EMBODIMENTS OF THE INVENTION

“Window cover” as defined and used herein, refers to a thermal and illumination barrier. An “inhabitable vehicle”, as defined and used herein, is a vehicle that includes accommodations for sleeping, and so may include over-the-road trucks, recreational vehicles, boats, ships, trains, infantry vehicles, airliners and other aircraft with sleeping facilities (airborne or when landed), and the like.

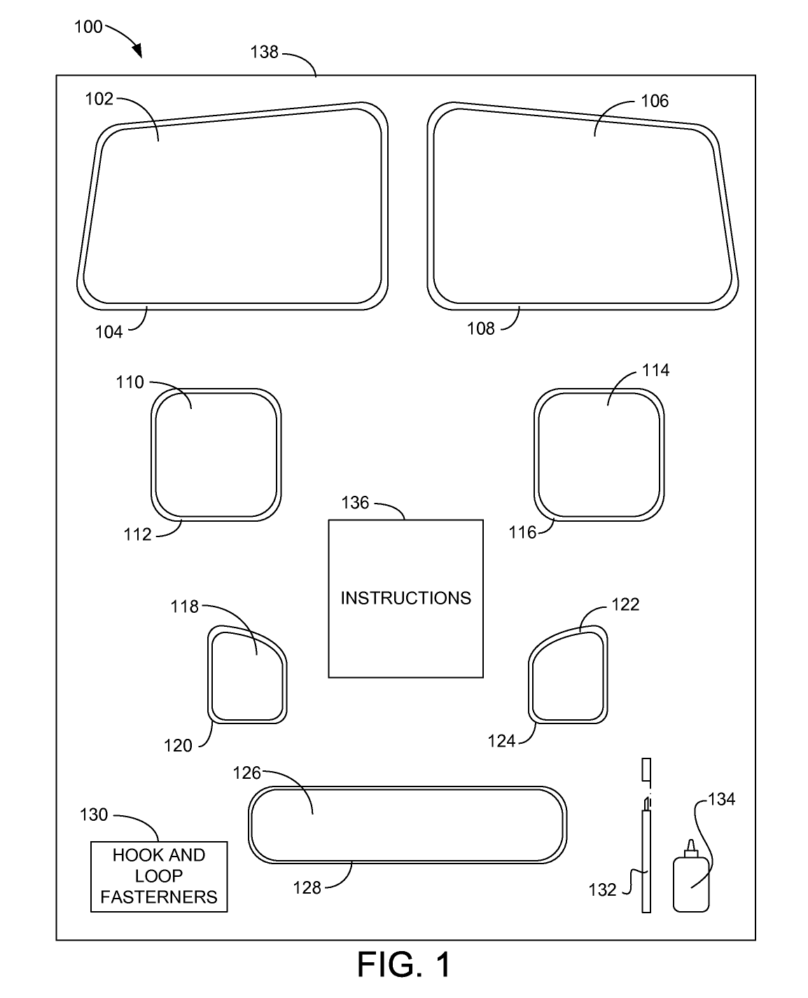

FIG. 1 is a diagrammatic view illustrating an exemplary window insulation kit 100 for inhabitable multi-windowed vehicles, according to a preferred embodiment of the present invention. Kit 100 includes left windshield cover 102 with perimeter seam 104 and right windshield cover 106 with perimeter seam 108. Kit 100 also includes left door window cover 110 with perimeter seam 112 and right door window cover 114 with perimeter seam 116. Kit 100 also includes left sleeping compartment window cover 118 with perimeter seam 120 and right door window cover 122 with perimeter seam 124. Kit 100 also includes sleeping compartment front window 126 with perimeter seam 128.

Kit 100 includes packaging 138, diagrammatically represented, which is preferably transparent over at least a portion of its surface to allow the purchaser to view the appearance of at least one of the window covers 102, 106, 110, 114, 118, 122, and 126. A tubular package 138 is preferred, into which window covers 102, 106, 110, 114, 118, 122, and 126 can be rolled up around couplings 130 and assistive implements 132 and 134.

Window covers 102, 106, 110, 114, 118, 122, and 126 are opaque and insulated. Preferably, window covers 102, 106, 110, 114, 118, 122, and 126 are preferably opaque to electromagnetic energy in the visible spectrum and in the infrared spectrum. In an alternate embodiment, window covers 102, 106, 110, 114, 118, 122, and 126 may be opaque only in the visible spectrum. Window covers 102, 106, 110, 114, 118, 122, and 126 are preferably machine washable but may be, in an alternate embodiment, only hand-washable.

Couplings 130, shown as hook and loop fasteners 130 are exemplary releasable couplings 130 for releasably attaching window covers 102, 106, 110, 114, 118, 122, and 126 to the inside surfaces 512, 514, and 506 of the vehicle 500 (See FIG. 5) in positions to cover their respective windows 502. Couplings 130 have first and second parts that are releasably attachable to each other. A first part of fastener 130 may be fixed to an interior surfaces 512, 514, and 506 of the vehicle 500 (See FIG. 5) and a second part may be fixed to the window covers 102, 106, 110, 114, 118, 122, and 126 in aligned positions on the shapes of the window covers 102, 106, 110, 114, 118, 122, and 126. In various alternate embodiments, other couplings 130 may be used. For example, and without limitation, snaps; button hole (in the seam) with cufflink type fastener or hook; various linear plastic snap closures, as known in the art of releasable plastic bag closures; zippers; clamps; and the like, may be used.

Glue dispenser 134 provides an exemplary implement for assisting in attaching a portion of a releasable coupling 130 to the inside surfaces 512, 514, and 506 of the vehicle 500 (See FIG. 5). The glue from glue dispenser 134, once set, should be able to withstand temperatures between minus 60° F. and positive 160° F. Marker 132 is another exemplary implement used to mark portions of the inside surfaces 512, 514, and 506 of the vehicle 500 to assist in installing portions of releasable couplings 130, such as a hook section of a hook and loop fastener 540 (See FIG. 5), onto the inside surface 514 of the vehicle 500. Marker 132 is preferably a washable marker. In various alternate embodiments, other implements 132 and 134, appropriate to assist in installation of the various types of couplings 130 used in various alternate embodiments, will be included in the alternate embodiment kits.

Instructions 136 provide text, diagrammatic, and/or video instructions on how to install the window covers 102, 106, 110, 114, 118, 122, and 126 using the couplings 130. Instructions 136 preferably also include instructions for machine washing the window covers 102, 106, 110, 114, 118, 122, and 126. Instructions 136 also preferably include templates for aligning couplings 130 to the windows and/or widow covers 102, 106, 110, 114, 118, 122, and 126. In a particular embodiment, the templates may be integral to the widow covers 102, 106, 110, 114, 118, 122, and 126. For non-limiting example, a template may comprise locations where hook portions of hook and loop fasteners 130 are sewn to the window covers 102, 106, 110, 114, 118, 122, and 126. By attaching loop portions of hook and loop fasteners 130 to the sewn-on hook portions, the consumer may apply glue to the backs of the loop portions, hold the window cover 102 in place over a corresponding window, press the glue-bearing backs of the loop portions onto an interior vehicle surface surrounding the window, and wait for the glue to fully cure before removing the window covering 102 by releasing the hook and loop fasters 130. Thus, the exemplary window cover 102 incorporates the template.

The shapes, numbers, and types of window covers 102, 106, 110, 114, 118, 122, and 126 are merely exemplary. The actual shapes and number of window covers 102, 106, 110, 114, 118, 122, and 126 in a particular kit 100 will depend on the model of vehicle for which the kit 100 is made. Computer-aided design and manufacturing make it comparatively easy to store a large number of patterns for production, and to produce product as demand evolves. Likewise, vehicle manufacturers may present new and different windows to cover, and the present invention adapts to such new shapes and changes. In an alternate embodiment, window covers 102, 106, 110, 114, 118, 122, and 126 may have compromised shapes, such that they will functionally fit the windows of several different models of trucks without fitting any one truck's windows perfectly.

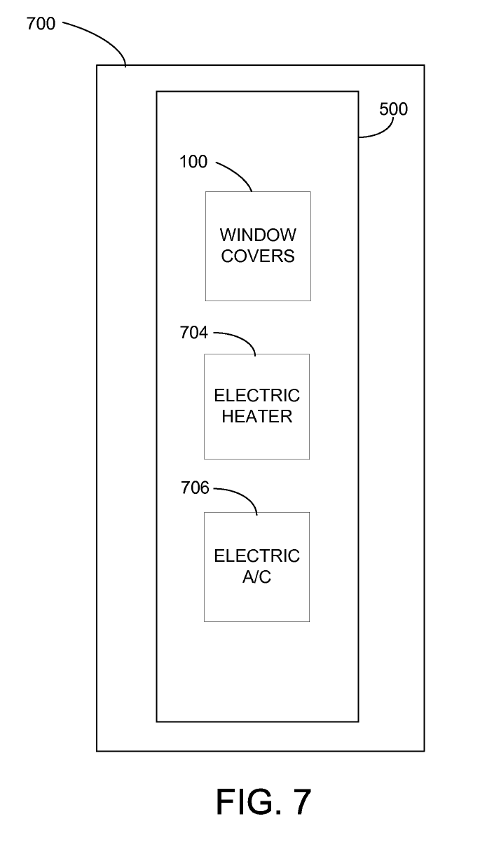

The invention also includes vehicles 500 equipped with couplings 540, 542 (see FIG. 5) for thermal and illumination barriers on all windows 502. Thus, if vehicle manufacturers make such couplings 540, 542 standard equipment and ship the vehicle 500 and the window covers 102, 106, 110, 114, 118, 122, and 126, that would constitute a kit 100 that also included a vehicle 500 and is within the scope of the present invention. Some electric air conditioners 706 (see FIG. 7) and heaters 704 for over-the-road trucks are commercial-off-the-shelf after-market devices for older trucks 500 and may be sold as part of a kit 100.

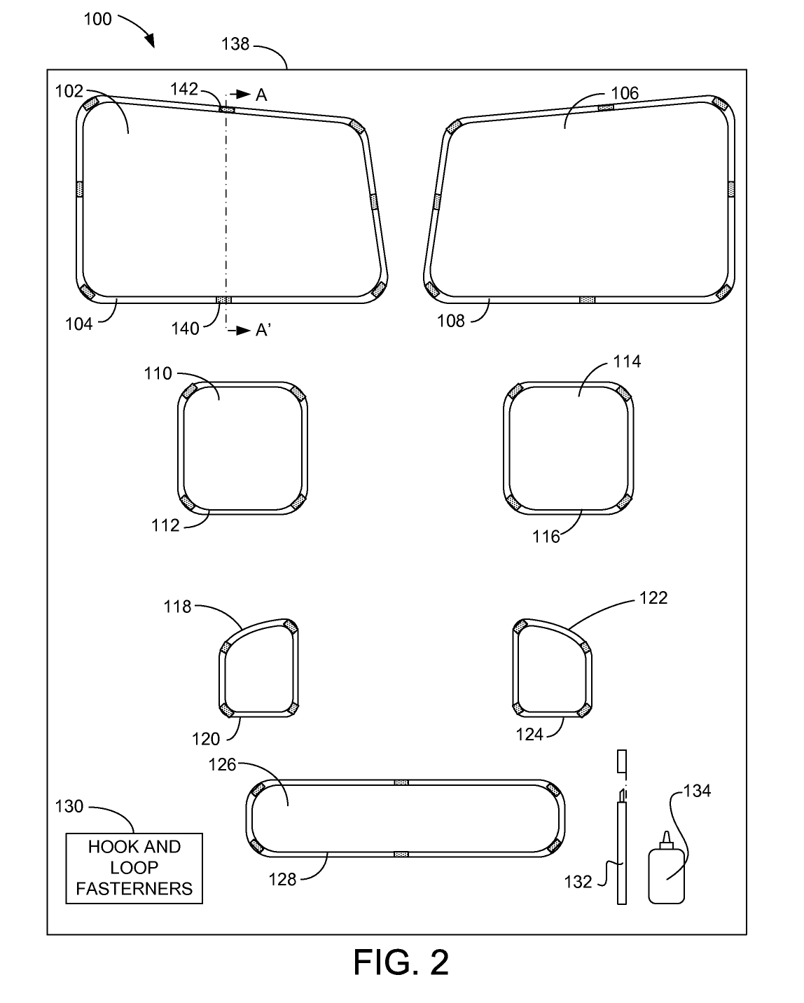

FIG. 2 is a diagrammatic view illustrating the reverse sides of the exemplary window thermal and illumination barriers, or window covers, 102, 106, 110, 114, 118, 122, and 126 of the exemplary window insulation kit 100 for inhabitable multi-windowed vehicles 500, according to a preferred embodiment of FIG. 1. The reverse sides illustrated in FIG. 2 have first portions 140, 142 (two of thirty-eight labeled) of couplings 130 attached to seams 104, 108, 112, 116, 120, 124, and 128. While the invention is not limited to any particular type of coupling 130, hook-and-loop fasteners, such as those commercially sold as VELCRO®, are preferred for cost and simplicity reasons. The positions of the first portions 140, 142, and others mirror positions of complimentary second portions 540, 542 (see FIG. 5) of couplings 130 attached to the inside surface 514 of the vehicle 500. The complimentary second portions 540, 542 of couplings 130 attached to the inside surface 514 of the vehicle 500 may be attached to the surface 514 of the inside of the vehicle 500, as with first portions 140, 142 of hook-and-loop couplings 130. In an alternate embodiment, portions of various other types of complimentary second portions 540, 542 of couplings 130 may be attached to the vehicle structure 508. In yet another alternate embodiment, the complimentary portions of various other types of couplings 540, 542 may be made integral to the vehicle 500. Any of the interior surfaces 512, 514, and the interior surface 506 of the window 502 may support second portions 540, 542 of couplings 130.

The first portions 140,142 of couplings 130 may be positioned in various patterns on the seams 104, 108, 112, 116, 120, 124, and 128: the pattern shown is merely exemplary. In an alternate embodiment, the first portions 140,142 of couplings 130 may be attached, at least in part, to the non-seam portion of the window covers 102, 106, 110, 114, 118, 122, and 126

Kit 100 includes window covers 102, 106, 110, 114, 118, 122, and 126 with first portions 140, 142 of couplings 130 only on one side. In an alternate embodiment, one or more of window covers 102, 106, 110, 114, 118, 122, and 126 may be reversible and have first portions 140, 142 of couplings 130 on both sides.

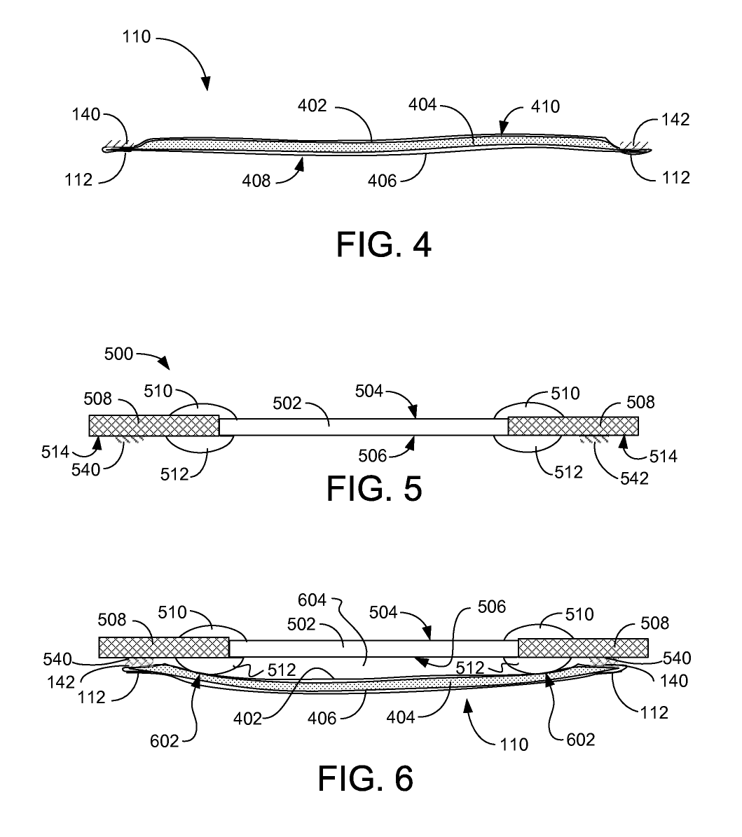

Cross section A-A′ of window cover 110 is discussed more fully below in regard to FIG. 4 and FIG. 6.

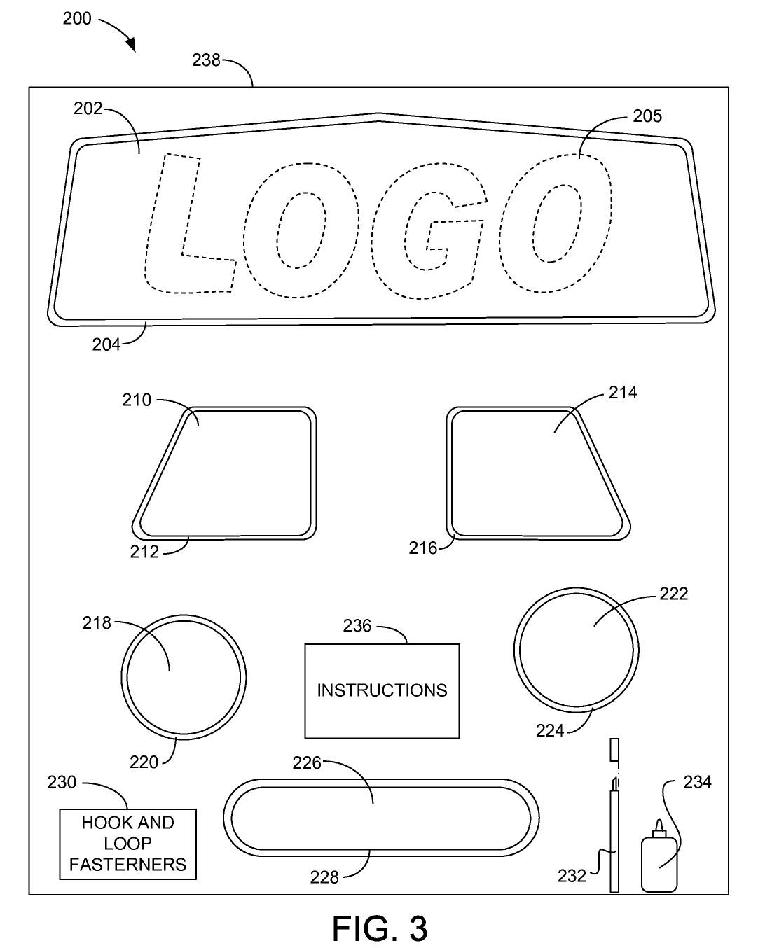

FIG. 3 is a diagrammatic view illustrating another exemplary window 502 insulation kit 200 for inhabitable multi-windowed vehicles 500, according to a preferred embodiment of the present invention. Windshield cover 202 with seam 204 and logo 205 is shaped for a vehicle 500 having a single continuous windshield rather than a bisected windshield, for which windshield covers 102 and 104 would be more appropriate. The window covers 102, 106, 110, 114, 118, 122, 126, 202, 210, 214, 218, 22, and 226 may function as advertising or display media, as illustrated with logo 205 on windshield cover 202. This requires that the exterior surface 410 or 408 (See FIG. 4) be capable of supporting the additional material that forms the logo 205. The additional material may be, for non-limiting examples, stain, ink, paint, fabric, foil, and the like. The particular logo 205 illustrated is not part of the present invention. Logo 205 may be created by any known method, such as fabric paint, dye, appliqué, or sewing of various sheets of fabric together to make one side of the window cover 202. Logo 205 serves the function of making the kits 100 and 200 easier to sell. Window covers 102, 106, 110, 114, 118, 122, 126, 202, 210, 214, 218, 22, and 226 may be of various colors, may have different colors on opposite sides, and may have reflective properties.

Kit 200 also includes left door window cover 210 with perimeter seam 212 and right door window cover 214 with perimeter seam 216. Kit 200 also includes left sleeping compartment window cover 218 with perimeter seam 220 and right sleeping compartment door window cover 222 with perimeter seam 224. Kit 200 also includes sleeping compartment front window 226 with perimeter seam 228. It must be appreciated that the present invention covers the entire variety of combinations of windows 502 as to shape and number in all multi-windowed inhabitable vehicles 500. Hook and loop fasteners 230 are the complimentary couplings 230 intended to be installed in the vehicle using glue form glue dispenser 234. Glue dispenser 234 may be sized differently than glue dispenser 134, due to different requirements for attaching complimentary couplings 230 to the vehicle 500 to couple to first and second portions 140, 142 of couplings 130 such as on the reverse side of seams 204, 212, 216, 220, 224, and 228 of window covers 202, 210, 214, 218, 22, and 226. Marker 232 illustrates that various types of markers 134, 232 may be used. Instructions 236 are different by virtue of being adapted to a different kit 200 of window covers 202, 210, 214, 218, 22, and 226.

FIG. 4 is a side cross-section diagrammatic view through cross-section A-A′ of an exemplary window thermal and illumination barrier 110, or window cover, 110, according to the preferred embodiment of FIG. 1 and FIG. 2. First side 402 and second side 406 are preferably water-resistant washable flexible fabrics with low permeability to air and liquids. For example, flag fabric, a 210-denier nylon, obtainable through Noah Lamport, Inc. of Los Angeles, Calif., works well for the present purpose. Between first and second sides 402 and 406, is insulation 404 that is preferably multilayered insulation 404. Multilayered insulation 404 preferably has resilient air-trapping layers intermixed with flexible reflective layers, such as aluminized mylar, and is capable of being sewn. For example, such a material is marketed as Warm Window and is manufactured by Warm Products, Inc. of Seattle, Wash. The resilience, or pillow-like softness, of the window covers 102, 106, 110, 114, 118, 122, 126, 202, 210, 214, 218, 22, and 226 is crucial to creating an effective barrier to both heat transfer and light infiltration. The air-trapping layers of multilayered insulation 404 comprises a soft bulk material that enables the window covers 102, 106, 110, 114, 118, 122, 126, 202, 210, 214, 218, 22, and 22 to deform conformally to an edge feature (such as 512) of the window 502 to produce a light-tight perimeter seal 602 (See FIG. 6) at an edge of the window 502. Other multilayered insulation 404 materials, capable of similar functions may be substituted, in various alternate embodiments, for those given as examples. The multilayered insulation 404 is sewn into the seam 112 between first side 402 and second side 406 to prevent bunching.

FIG. 5 is a side cross-section diagrammatic view of a portion of a vehicle 500 illustrating an exemplary vehicle window 502 in a vehicle structure 508 with second portions 540, 542 of couplings attached thereto, according to a preferred embodiment of the present invention. Vehicle 500, in relevant part, includes window 502, vehicle structure 508 supporting the window 502, interior window molding 512, and exterior window molding 510. Window 502 has an exterior surface 504 and an interior surface 506. Second portions of couplings 540, 542 are attached to vehicle structure 508. For example, second portions 540, 542 of couplings 130 may be hook portions of hook-and-loop releasable fasteners while first portions 140, 142 of couplings 130 are loop portions of hook and loop releasable fasteners. Vehicle structure 508 includes actual structure and also interior paneling, if any. Vehicle structure 508 also includes interior vehicle surface 514 which may be a surface of the vehicle structure, per se, or any interior paneling or equivalent. The interior and exterior moldings 512, 510 are represented diagrammatically, and may be of various shapes and sizes in various models of vehicles 500, even to the extent of not appearing as discrete elements, but merging into vehicle structure 508 seamlessly.

The placement of portions 540, 542 of couplings 130 is exemplary. In various alternate embodiments, the portions 540, 542 of couplings 130 may be placed on the interior molding 512 or the window interior surface 506.

FIG. 6 is a side cross-section diagrammatic view illustrating the exemplary window thermal and illumination barrier 110 of FIG. 4 coupled to a portion of vehicle 500 with second portions 540, 542 of couplings 130 attached thereto to cover the window 502, according to the preferred embodiment of FIG. 4 and FIG. 5. First portions 140, 142 of couplings 130 releasably couple to second portions 540, 542 of couplings 130, respectively. It is preferred that the windshield cover 110 is sized to extend beyond the perimeter of window 502, as shown. It is also preferred that the windshield cover 110 compliantly and conformally engage non-window surfaces, such as interior molding 512 at extents 602, to reduce light infiltration and thermal transfer of the air in the space 604 between the window 502 and the windshield cover 110. In alternate embodiments, this can be accomplished with the releasable couplings 140-540 and 142-542 being placed on the interior molding 602 or on the window 502, as long as a sufficient non-seam portion of window cover 110 compliantly and conformally engages vehicle structure 508, window surface 506, and/or window molding 512 to reduce light infiltration and thermal transfer.

FIG. 7 is a diagrammatic view illustrating yet another exemplary window insulation kit 700 for inhabitable multi-windowed vehicles 500, according to a preferred embodiment of the present invention. Kit 700 includes a window insulation kit 100, and one or more of an inhabitable multi-windowed vehicle 500, an electric heater 704 and an electric air conditioner 706. Electric heater 704 may be, for non-limiting example, a 12-volt, 480-Watt POWERHUNT® heater produced by PNP System Inc. of Tualatin, Oreg. Electric air conditioner 706 may be, for non-limiting example, a self-contained 7,000 BTU Model ASCF7 air conditioner offered for sale by Domestic Corporation of Richmond, Va. In a particular embodiment, electric heater 704 and electric air conditioner 706 may be integrated into a single unit such as, for non-limiting example, the Model ASCEQ7 heater/air conditioner offered for sale by Domestic Corporation of Richmond, Va. The inhabitable multi-windowed vehicle 500 is exemplified as a truck with a sleeper cab, but may be any type of inhabitable multi-windowed vehicle 500. The kit 700 would preferably include the electric heater 704 in its original packaging and with its ancillary and accessory items, and electric air conditioner 706 in its original packaging and with its ancillary and accessory items. In an alternate embodiment, at least some of the parts, ancillary items, and/or accessory items of electric heater 704 and electric air conditioner 706 may be repackaged into kit 700. An inhabitable multi-windowed vehicle 500, offered for sale with a window insulation kit 100 as a promotional consideration in the sale of the vehicle 500, would be an exemplary embodiment of kit 700. Window insulation kit 100 offered for sale with an electric heater 704 would be another exemplary embodiment of kit 700. Window insulation kit 100 offered for sale with an electric air conditioner 706 would be yet another exemplary embodiment of kit 700. Window insulation kit 100 offered for sale with an electric heater 704 and an electric air conditioner 706 would be still yet another exemplary embodiment of kit 700. The power source for the electric heater 704 and the electric air conditioner 706 is preferably the batteries of the vehicle 500. In an alternate embodiment, other power sources, not including the engine of the vehicle 500, may be used. For example, some models of electric heater 704 and electric air conditioner 706 have self-contained battery packs.

The embodiments shown are exemplary, and the invention is only limited by the claims below as interpreted in light of the specification.

I claim:

1. A kit for providing window insulation for a multi-windowed inhabitable vehicle, the kit comprising:
a. a plurality of opaque and insulated window covers, comprising one window cover corresponding to each such window in such multi-windowed inhabitable vehicle, wherein each said window cover is shaped conformally to the shape of a respective said corresponding window and sized to extend beyond the perimeter of said respective said corresponding window;
b. a plurality of couplings operable to couple each window cover of said plurality of window covers to at least one interior surface of said vehicle; and
c. a set of instructions operable to present at least a method of employing said plurality of couplings to couple said plurality of said window covers to at least one interior surface of said vehicle.

2. The kit of claim 1, further comprising an implement for assisting in coupling said plurality of opaque and insulated window covers to said at least one interior surface of said vehicle.

3. The kit of claim 2, wherein said implement comprises at least one of a marker and an adhesive dispenser.

4. The kit of claim 1, further comprising said multi-windowed inhabitable vehicle.

5. The kit of claim 1, further comprising an electric heater.

6. The kit of claim 1, further comprising an electric air conditioner.

7. The kit of claim 1, wherein said window cover is opaque to electromagnetic energy in the visible spectrum and in the infrared spectrum.

8. The kit of claim 1, wherein said window cover comprises:
a. first and second opposed outer layers of a water-resistant fabric sandwiching a multilayer insulating material; and
b. a perimeter seam formed in said first and second opposed outer layers of said water-resistant fabric and said multilayer insulating material.

9. The kit of claim 8, wherein said multilayer insulating material comprises soft bulk sufficient to enable said window cover to deform conformally to an edge feature of said window to produce a light-tight perimeter seal at an edge of said window.

10. The kit of claim 8, wherein said water-resistant fabric comprises an outer surface adapted to support at least one additional material.

11. The kit of claim 1, wherein said plurality of couplings comprises at least one coupling comprising first and second parts that are releasably attachable to each other, wherein said first releasably attachable part is fixable to said at least one interior surface of said vehicle and said second releasably attachable part is fixable to said window cover.

12. The kit of claim 1, wherein said set of instructions may comprise at least one of:
a. a plurality of templates for arranging said plurality of couplings proximate a corresponding said plurality of windows; and
b. machine washing instructions for washing said window cover.

13. A kit for providing window insulation for a multi-windowed inhabitable vehicle, the kit comprising:
a. a plurality of opaque and insulated window covers, comprising one window cover corresponding to each such window in such multi-windowed inhabitable vehicle, wherein each said window cover is sized to extend beyond the perimeter of said respective said corresponding window;
b. a plurality of couplings operable to couple each window cover of said plurality of window covers to at least one interior surface of said vehicle;
c. a set of instructions operable to communicate at least a method of employing said plurality of couplings to couple said plurality of said window covers to at least one interior surface of said vehicle;
d. an implement for assisting in coupling said plurality of opaque and insulated window covers to said at least one interior surface of said vehicle; and
e. wherein said window cover comprises:
i. first and second opposed outer layers of a water-resistant fabric sandwiching a multilayer insulating material, wherein said multilayer insulating material comprises soft bulk sufficient to enable said window cover to deform conformally to an edge feature of said window to produce a light-tight perimeter seal at an edge of said window; and
ii. a perimeter seam formed in said first and second opposed outer layers of said water-resistant fabric and said multilayer insulating material.

14. The kit of claim 13, further comprising said multi-windowed inhabitable vehicle.

15. The kit of claim 13, further comprising an electric heater.

16. The kit of claim 13, further comprising an electric air conditioner.

17. The kit of claim 13, wherein said window cover is opaque to electromagnetic energy in the visible spectrum and in the infrared spectrum.

18. The kit of claim 13, wherein said plurality of couplings comprises at least one coupling further comprising first and second parts that are releasably attachable to each other, wherein said first releasably attachable part is fixable to said at least one interior surface of said vehicle and said second releasably attachable part is fixable to said window cover.

19. A kit for providing window insulation for a multi-windowed inhabitable vehicle, the kit comprising:
a. a plurality of opaque and insulated window covers, comprising one window cover corresponding to each such window in such multi-windowed inhabitable vehicle, wherein:
i. each said window cover is shaped conformally to the shape of a respective said corresponding window and sized to extend beyond the perimeter of said respective said corresponding window; and
ii. said window cover is opaque to electromagnetic energy in the visible spectrum and in the infrared spectrum;
b. a plurality of couplings operable to couple each window cover of said plurality of window covers to at least one interior surface of said vehicle, wherein said plurality of couplings comprises at least one coupling further comprising first and second parts that are releasably attachable to each other, wherein said first releasably attachable part is fixable to said at least one interior surface of said vehicle and said second releasably attachable part is fixable to said window cover;
c. a set of instructions operable to present a method of employing said plurality of couplings to couple said plurality of said window covers to at least one interior surface of said vehicle, wherein said set of instructions further comprises at least one of:
i. a plurality of templates for arranging said plurality of couplings proximate a corresponding said plurality of windows, wherein said template may be integral to said window cover; and
ii. machine washing instructions for washing said window cover;
d. an implement for assisting in coupling said plurality of opaque and insulated window covers to said at least one interior surface of said vehicle; and
e. wherein said window cover comprises:
i. first and second opposed outer layers of a water-resistant fabric sandwiching a multilayer insulating material, wherein:
1. said multilayer insulating material comprises soft bulk sufficient to enable said window cover to deform conformally to an edge feature of said window to produce a light-tight perimeter seal at an edge of said window; and
2. said water-resistant fabric comprises an outer surface adapted to support at least one additional material;
ii. a perimeter seam formed in said first and second opposed outer layers of said water-resistant fabric and said multilayer insulating material.

20. The kit of claim 19, further comprising at least one of:
a. said multi-windowed inhabitable vehicle;
b. an electric heater; and
c. an electric air conditioner.
